(19) United States
(12) Patent Application Publication
(10) Pub. No.: US 2014/0272910 A1
(43) Pub. Date: Sep. 18, 2014

(54) SYSTEM AND METHOD FOR ENHANCED TEACHING AND LEARNING PROFICIENCY ASSESSMENT AND TRACKING

(71) Applicant: Inteo, LLC, Covington, KY (US)

(72) Inventors: Matteo P. del Ninno, Cincinnati, OH (US); Azamat Galimzhanov, Dublin (IE); Dennis Theurer, Celle (DE)

(73) Assignee: Inteo, LLC, Covington, KY (US)

(21) Appl. No.: 14/194,713

(22) Filed: Mar. 1, 2014

Related U.S. Application Data
(60) Provisional application No. 61/771,390, filed on Mar. 1, 2013.

(51) Int. Cl. G09B 7/06

(52) U.S. Cl. CPC G09B 7/06
USPC 434/362

(57) ABSTRACT

A system and method for assessing and tracking learning proficiency that includes presenting a problem for solution by a student in a workspace displayed on a student processing device and assessing a plurality of lines entered by the student in the workspace for correctness and correspondingly providing scores for each of the plurality of lines The system and method also includes modifying a plurality of assessed skill levels each based on the scores for each of the plurality of lines.

### CROSS-REFERENCE TO RELATED APPLICATIONS

This application claims priority to Provisional Patent Application Ser. No. 61/771,390, filed on Mar. 1, 2013, which is incorporated herein by reference in its entirety.

### BACKGROUND

Present educational systems and methods often produce less than optimal results, including marginal and unacceptable results. An improved educational system and method mitigating or overcoming problems associated with present educational systems and methods is desired.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry various features may not be drawn to scale and are used for illustration purposes only. In fact, the dimensions of the various features in the drawings may be arbitrarily increased or reduced for clarity of discussion.

FIG. 1 is a block diagram of an enhanced teaching and learning proficiency assessment and tracking system in accordance with some embodiments.

FIG. 2 is a computer screen display depicting a mathematical problem having two parts solvable with a step-by-step approach with an enhanced teaching and learning proficiency assessment and tracking system in accordance with some embodiments.

FIG. 3 is a computer screen display depicting a mathematical problem having multiple parts solvable with a tabbed approach with an enhanced teaching and learning proficiency assessment and tracking system in accordance with some embodiments.

FIG. 4 is a computer screen display depicting of a graded workspace with an enhanced teaching and learning proficiency assessment and tracking system in accordance with some embodiments.

FIG. 5 is a computer screen display depicting retention and usage of particular skills over time with an enhanced teaching and learning proficiency assessment and tracking system in accordance with some embodiments.

FIG. 6 is a computer screen display depicting user problem creation with an enhanced teaching and learning proficiency assessment and tracking system in accordance with some embodiments.

FIG. 7 is a computer screen display depicting assessment of how a user steps through a problem with an enhanced teaching and learning proficiency assessment and tracking system in accordance with some embodiments.

FIG. 8 is a computer screen display depicting a graphical user interface displaying goals and milestones with an enhanced teaching and learning proficiency assessment and tracking system in accordance with some embodiments.

FIG. 9 is a computer screen display depicting assessment of user skills and presentment of a skill proficiency to the user while the user is working out problems with an enhanced teaching and learning proficiency assessment and tracking system in accordance with some embodiments.

FIG. 10 is a computer screen display depicting tables displaying proficiency tracking with an enhanced teaching and learning proficiency assessment and tracking system in accordance with some embodiments.

FIG. 11 is a block diagram of a computer system portion of an enhanced teaching and learning proficiency assessment and tracking system in accordance with some embodiments.

FIG. 12 is a flowchart of method of assessing and tracking learning proficiency with an enhanced teaching and learning proficiency assessment and tracking system in accordance with some embodiments.

FIG. 13 is a flowchart of method of assessing and tracking learning proficiency having score weighting with an enhanced teaching and learning proficiency assessment and tracking system in accordance with some embodiments.

FIG. 14 is a block diagram of a workspace having a problem solution with multiple steps and one of the steps having multiple lines in an enhanced teaching and learning proficiency assessment and tracking system in accordance with some embodiments.

### DETAILED DESCRIPTION

Various non-limiting embodiments of the present disclosure will now be described to provide an overall understanding of the principles of the structure, function, and use of the proficiency tracking systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Described herein are example embodiments of computer-based systems and methods for enhanced teaching and learning proficiency assessment and tracking. In some embodiments, a problem, such as an algebra problem, is presented to a student whose solution encompasses multiple assessed skills and assessments of student proficiency of those skills, i.e., scores and grades, is determined using a variety of techniques as described herein. In some embodiments, an overall score of the solution to the problem is provided. In some embodiments, one or more skills are assessed line-by-line while the problem is being worked by the student in real time.

The examples discussed herein are intended to be illustrative only to assist in explanation of the apparatuses, devices, systems and methods described herein. Features or components shown in the drawings or discussed below should not be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not envisioned. Also, for any methods described, regardless of whether the method is described in conjunction with a flow chart, it should be understood that unless otherwise specified or required by context, any explicit or implicit ordering of steps performed in the execution of a method does not imply that those steps must be performed in the order presented but instead may be performed in a different order or in parallel.

Various singular and plural terms for system and method users, such as “teacher,” “student,” “class” and “classroom,” as used herein, are intended only to illustrate an interaction between such users and an enhanced teaching and learning proficiency assessment and tracking system, and are not intended to limit users to specific roles or functions, unless otherwise indicated herein. For example, in some embodiments, both teacher and students create problems reviewed and solved by the other.

Some embodiments described herein enhance teaching through identification of relative strengths and weaknesses in each individual student as well as in a group of students making up the classroom. The term “classroom” does not necessarily designate a single time or place. Some embodiments described herein and collect real-time assessment and tracking of student proficiency through a variety of metrics. For example, measurements collected by a computer system based on a student's interaction with problems used to assess and track particular skills In some embodiments, student computer workspace derived measurements and/or manual input of skills assessments by a teacher are used for determining student proficiency.

A proficiency assessing computing method and system presents students with a series of scholastic environment problems, e.g., algebra problems, analyzes each line entered by the student to solve such problems, assesses the validity of each line independently, relates the assessed validity of each line to a defined skill and solution to the problem stores collects the measurements, and processing the measurements, as described in more detail below. The proficiency assessing computing system is not limited to any particular computing system and in some embodiments employs a dedicated server, a user computer or server, multiple networked computers, a cloud-based computer system, a web-based computer system, etc. One or multiple processing units, such as central processing units and/or graphics processing units, perform instructions stored in memory to execute the processes described herein. As described in more detail below, the proficiency assessing computing system generates one or more workspaces allowing users to interact with the system. Through such interaction, proficiency of various skills are monitored, measured, and tracked. An enhanced teaching and learning proficiency assessment and tracking system in accordance with the present disclosure is accessed via any suitable technique, such as a web-browser such as Firefox, Opera, Safari, Google Chrome, Internet Explorer, or the like executing on a client device. In some embodiments, the systems and methods described herein include a web-based software application or a stand-alone executable file on a tangible computer-readable medium. Additionally, in some embodiments, the systems and methods described herein integrate with various types of learning management systems, such as Blackboard, Moodle, and the like. In some embodiments, an enhanced teaching and learning proficiency assessment and tracking system in accordance with the presently disclosed embodiments provides a workspace that is accessible via any suitable client device such as a laptop computer, desktop computer, smart phone, tablet computer, gaming system, and the like.

Workspace environments that are provided by the systems and methods described herein generally provide users (e.g., students) the ability to work problems and demonstrate aptitude. In some embodiments, interaction with the workspace includes, without limitation, keyboard entry, writing from pen, stylus, finger, or the like, with a computer mouse, or other forms of input (voice recognition, etc.). In some embodiments, the workspace is presented on a tablet, desktop, phone, board, or paper. In some embodiments, the user interacts with a workspace environment by writing with a smart pen on normal paper, modified paper, or a hard flat surface of their preference. In this embodiment, the user receives real-time feedback, or at least near real-time feedback, or synchronizes with a proficiency assessing computing system at a later date. In some embodiments, the proficiency assessing computing system is a personal computer, one or multiple computers in server-type system.

In some embodiments, user interaction with the proficiency assessing computing system takes place in any of a variety of operational environments, such as classroom setting or a home setting, with one or more students interacting with the system at a given time.

FIG. 1 is a block diagram of an enhanced teaching and learning proficiency assessment and tracking system 100 in accordance with some embodiments. A teacher 102 is provided with access to a teacher processing device 104 such as a computer with a display. In some embodiments, the teacher processing device 104 is provided for use by the teacher 102, but not by others in a classroom. In some embodiments, the processing device 104 is communicatively coupled to at least one student processing device 106, such as a computer with a display. There are N student processing devices 106, each of the N student processing devices providing access and workspace for one of N students 108, with N being any positive integer. In some embodiments, some students share workspace in student processing device 106.

In some embodiments the teacher 102 uses the teacher processing device 104 to monitor problems, such as science, technology, engineering, and mathematics (STEM) problems, being worked on by one student 108 in the workspace provided by the student processing device 106. In some embodiments, for example, a classroom of N students individually work out problems using a smart pen such as Livescribe and a local proficiency measuring system executing on each student processing device 106, such as a Rasberry Pi, to assess and track student 108 learning performance as described herein. The teacher 102 has the option to view student 108 entries into student workspace in real-time, as submitted, and/or as graded work. Graded work includes line-by-line scores of the finest granularity in which each line represents a separate correct or incorrect application of a skill Graded work also includes an overall score reflecting solution of the problem as a whole. While some problems are readily solved with a single skill, e.g., simple arithmetic solves “2+2”, other problems, e.g., multiple variable algebraic equations, often involve application of multiple skills to properly solve. In some embodiments, a correct or incorrect score is assigned for each line entered into the student workspace of the student processing device 106 that correspondingly correctly or incorrectly applied a skill whether or not the problem is solvable without application of those skills In other embodiments, a correct or incorrect score is assigned for each line entered into the student workspace of the student processing device 106 that correspondingly correctly or incorrectly applied a skill if the problem is not solvable without application of those skills In some embodiments, a correct result is a condition precedent for entry of line-by-line scores assessing separate skills

In some embodiments, a teacher 102 views the display of the teacher processing device 104 displaying real-time student skills assessment during a class. The assessment is presented in any suitable subset of the class, such as an individual student, a collection of students, or the entire class. Based on the skills assessment, as presented by the enhanced teaching and learning proficiency assessment and tracking computing system 100, the teacher is informed by the system 100 about mistakes made by that subset of students and thereby enabled to assist those students to correct their mistakes. In some embodiments, the system 100 informs the teacher 102 that a threshold number of students are making common mistakes enhances teaching by recommending that the teacher address the entire class to correct such a wide-spread failure to grasp certain skills or concepts, as manifested by the errors made by the students 108 working through their problems. In some embodiments, the system recommends the teacher 102 address only those students making common mistakes and not the entire class.

In some embodiments, the teacher 102 or student 108 works through a problem and others are given access through their processing device 104, 106 to view that work as a teaching tool. Thus, in some embodiments, the teacher 102 presents a particular problem and a solution to any desired subset of the class. The teacher 102 then enables the problem to be displayed to the students 108 at their election for their subsequent review, such as while the students are reviewing class notes, attempting homework assignments, or studying for an exam.

The enhanced teaching and learning proficiency assessment and tracking system 100 described herein enables the user 102, 108 to create, work through, and re-arrange equations to solve problems. In some embodiments, the user 102, 108 selects a portion of an equation and then enters a solution to that portion of the equation. In some embodiments, a user designates (“tab”) a selected portion of a problem in order to work through that portion of a problem in another workspace displayed by the processing device 104, 106 and then substitute a corresponding answer back into the workspace for the original problem. In some embodiments, the system 100 makes proficiency assessments based upon these substitutions. For example, if a student 108 highlights “x*x” in an equation and chooses to substitute that portion of the equation with “2x”, the student receives a score of “0” for the skill assessment associated with multiplying like variables. Alternatively, the student 108 receives a score of “1” for a skill assessment associated with multiplying like variables if “x²” is substituted.

In one example of user 102, 108 interaction with a mathematical problem presented by the system 100, the user has at least one option to:
Use the associative property;
Use the distributive property;
Expand parts of the equation/perform factoring, for example, the student 108 expands a problem from (x+1)² to (x+1)(x+1);
Combine terms, for example, the combination of terms such as from (3x+4x) to (7x);
Separate numbers, fractions, or variables, for example, expand 9 into 3*3 or 4+5. Another example is be to expand 3x to 2x+x or x+x+x; and
Add to, subtract from, multiply by, divide by, and raise to the power of: an input to both sides, for example, multiply both sides of an equation by −1, add 3 to both sides of the equation, raise each side to the power of a real or imaginary number.

In some embodiments, the student 108 employs aids, such as real-time checking, real-time grading, and hints. The system 100 tracks use of these functions to assess how the student solved the problem. The availability of such aids is controlled by a person or institution in charge of teaching or assessing the student 108, such as the teacher 102.

FIG. 2 is a computer screen display depicting a mathematical problem having two parts solvable with a line-by-line (step-by-step) approach 200 with an enhanced teaching and learning proficiency assessment and tracking system in accordance with some embodiments. In some embodiments, the user breaks up the mathematical problem into different components, for example, to solve for the “x” coordinate of a point of intersection between two lines. In this example, a first part of the problem is to solve for y in both equations. A next part of the problem is to set y of both equations equal to each other and solve for x. Each line after an initial setup of the problem is assessed separately as a mathematical skill An overall score for the problem is also assessed.

FIG. 3 is a computer screen display depicting a mathematical problem having multiple parts solvable with a tabbed approach 300 with an enhanced teaching and learning proficiency assessment and tracking system in accordance with some embodiments. The problem here is the same problem as in FIG. 2, but solved with tabs as illustrated in FIG. 3. A user employs tabs to separate and complete sections of the problem, as illustrated in FIG. 3. Under Tab 2 the user solves equation 2 for y separately from the workspace for the problem. The user plugs the solution for y derived under tab 2 back into the workspace in the first line. Each line after an initial setup of the problem is assessed separately as a mathematical skill In some embodiments, the user adds a variable to the workspace not present in the problem as presented. The system tracks the variable and checks for internal consistency in the workspace as if the variable were part of the problem as presented. In this fashion, the user is given greater freedom to solving the problem by allowing new variables to be introduced by the user. An overall score for the problem is also assessed.

FIG. 4 is a computer screen display depicting of a graded workspace 400 with an enhanced teaching and learning proficiency assessment and tracking system in accordance with some embodiments. A student interacting with a workspace has worked a solution for the variable x that is graded by the system. As shown, the enhanced teaching and learning proficiency assessment and tracking system determined that each line was correct and assigned the student a score of 10 for each of the tagged skills associated with the problem.

In some embodiments, a user is given access to one or more tools, resources, and aids provided via the workspace from the enhanced teaching and learning proficiency assessment and tracking system. For example, a user is given the skill to “check” their solution by inputting it into various previous steps to ensure the equation is still valid. In some embodiments, this is a method for a user to check their work before submitting it. The user uses tools as guides for building or solving an equation. An example of a tool is a linear equation such as y=mx+b. A user progressively enters their work for their personal skills assessment by determining when to move to the next line. An example of this is pressing the enter key on a keyboard to effectively submit work on a current line and transition current work to the next line.

In some embodiments, the user's available aids base for access to tools is determined based on that user's skills achievements. For example, a user who has shown proficiency in creating linear equations is conditionally enabled to import the point-slope line formula y=mx+b into the workspace without entering or deriving it themselves because of previous demonstrated proficiency with proper application of the formula. Other examples include enabling a user to conditionally replace like terms such as x+x with 2x if the use has shown proficiency in combining like terms. The system also unlocks skills and tools based on module completion or teacher manual input. A proficiency assessing computing system, as described herein, is configured to host users such as students and teachers, as well as to enable multiple methods of interaction between themselves or each other.

In some embodiments, problems stored by the enhanced teaching and learning proficiency assessment and tracking system are “tagged” with one or more skills that are to be assessed when a student works the problem. In some embodiments, a system for tagging problems:
Is used for the tagging of different skill sets related to each problem. For example, a student's performance of given skills is tracked based on the student's ability to complete the selected problem. A problem with the equation “(x²+2x+1=0)” is tagged as one or more of (1) a second order equation, (2) a multistep equation, (3) a graphing 2nd order equation, (4) solving for roots, and (5) recognizing a shared negative root;
Incorporates tagging specific skills to track a student's ability to solve a problem. This assessment occurs while the user is using a tool or skill while attempting to complete a problem. For example, while attempting to solve a problem such as: (x2+2x+1=0), if the student employs the quadratic formula they are recognized for a successful use of the quadratic formula, if the student uses factoring: the student is tagged as having used factoring, etc.;
Includes multiple types of work-out problems such as training problems for students to practice their skills outside of assignments, modules for learning concepts for skills (skill-builder), and additional practice problems to practice for homework or in tests; and
Is tagged by subject matter: math, chemistry, physics, etc. In some embodiments, a student filters problems on the training grounds based on that student's interests and teachers selectively assign real-world problems.

In some embodiments, functionality, navigation, and storage of the enhanced teaching and learning proficiency assessment and tracking system varies based on operational environment. Aspects of functionality, navigation and storage include:
An enhanced teaching and learning proficiency assessment and tracking system is functional from a teacher's perspective to select problems and modules, save them as a set, and assign sets to their students based on class curricula;
Teachers define or refine a timeline in which they set goals, assign tests/homework, and keep track of common core suggested pacing, a state's board of education suggested pacing, or a basic suggested pacing previously specified within the system;
Teachers track student skills, progress, and success of completion based on set milestones;
Teachers have an option to manually override assessments of student skills if the student has those demonstrated those skills outside of interaction with the workspace;
Students, in some embodiments, have to an ability to track assignments and milestones on their timeline, navigate to awards for assessed skills, and review a library of books or completed assignments/modules, practice problems (training center) and assignments; and
Monitor student skills being attributed to a profile, such as a student completes a module or assignment to specified proficiency in order to gain a tool to solve a problem.

FIG. 5 is a computer screen display depicting retention and usage of particular skills over time 500 with an enhanced teaching and learning proficiency assessment and tracking system in accordance with some embodiments. In some embodiments, the enhanced teaching and learning proficiency assessment and tracking system assesses student proficiency based on usage of a skill during work out of different problems or modules over time. This enables the system to determine a user's proficiency of the skill in different time frames, including more recent timeframes, as compared to when the skill was first introduced or assessed. Thus, retention of skills is assessed. FIG. 5 illustrates the temporal elements associated with the learning objectives or skills designated as “a,” “b,” “c,” “d,” “e,” “f,” and “g.” The system accounts for loss of retention, e.g., decreasing skill level over time often due to disuse and forgetting of that skill An example of this is a student receiving a high score for a skill which was assessed weeks, months, or years before the current time. An example of this is shown in FIG. 5, with respect to learning objective of skill “c”.

Integration with a Learning Management System (“LMS”)

In some embodiments, an enhanced teaching and learning proficiency assessment and tracking system systems is integrated with various learning management systems, such as Blackboard, Moodle, Scholar, and the like. Once integrated, the system is accessed through a portal from the LMS and accesses or stores information from the LMS. The system accesses the LMS to retrieve information such as student name, enrolled classes, current or pending assignments, and the like. In some embodiments, information stored by the system on the LMS includes proficiency assessments, grades, completed assignments, and the like. The system is able to synchronize with information and documents from the LMS.

Workspace Functionality

The methods and systems described herein enable the monitoring and study of student interaction beyond problem description and answer box. The workspace is an environment which exists between the problem description and the answer box. The system enables the user to work the problem until they are satisfied with their solution and then submit it for scoring. The system derives information with regard to student interaction with the workspace while working a problem.

In some embodiments, the system identifies a target skill with a score falling below a threshold value for a certain student and recommends further review to that student. The student is given the opportunity to review additional resources and/or problems for the purpose of improving assessed performance of the targeted skill by the student. In some embodiments the system directly prompts the student to review the additional resources and/or problems. In some embodiments the system indirectly prompts the student to review the additional resources and/or problems by recommending the student's teacher consider the system's recommendations first. In some embodiments the system introduces one or more problems requiring only the targeted skill to derive corresponding solutions, these are known as base problems. If a threshold number of base problems are successfully solved by the student, combination problems requiring multiple skills for their solution are presented to the student. In some embodiments, the combination problems are solvable with the targeted skill and another skill the student has satisfactorily mastered. In some embodiments, subsequent problems are solvable with the targeted skill and multiple other skills

FIG. 6 is a computer screen display depicting user problem creation 600 with an enhanced teaching and learning proficiency assessment and tracking system in accordance with some embodiments. In some embodiments, a user creates a problem from a problem statement. The system recognizes variables and correlates their value. In this manner, the system determines if the problem set up is valid by checking if the equation is valid and the values are equal to those correlating to the variables given such that the problem is internally self-consistent.

As illustrated in FIG. 6, a user is setting up a word-based math problem involving acquiring a correct number of apples to make an apple pie and the system is determines validity of the problem. The system checks validity of an equation on a line-by-line basis. If the problem is set up correctly and the user reaches the correct end value, then each line of valid equation in between the problem and solution will be correct as well. In some embodiments, the system employs an open platform in which steps of the equation are not mandated or pre-set. This enables a user to excel in math due to their preferences or unique solving method, while also allowing for proficiency assessment.

FIG. 7 is a computer screen display depicting assessment of how a user steps through a problem 700 with an enhanced teaching and learning proficiency assessment and tracking system in accordance with some embodiments. In some embodiments, the system determines that a user's work in a workspace is correct through a first two steps employed in solving a problem involving an equation but is incorrect at a third step. In some embodiments the system determines the value of the variable and uses it to check equation validity in order to designate it as incorrect and offer a hint to the user to correct the error the third step, or in any other step.

In some embodiments, the presently disclosed systems and methods provide a workspace that enables a teacher to create a schedule based on particular skills In some embodiments these skills correlate, for example, to common core standards of learning, a state's board of education standards of learning, or a basic set of core skills previously specified within the system. The teacher will be able to select from these particular skills as well as add others. In some embodiments, based on the selected skills, the teacher creates one or more goals for acquiring a minimum threshold level of assessed proficiency of these skills and creates milestones for completing goals.

FIG. 8 is a computer screen display depicting a graphical user interface displaying goals and milestones 800 with an enhanced teaching and learning proficiency assessment and tracking system in accordance with some embodiments. In some embodiments, deadline for completion of a module is generated and displayed on a timeline. If a student is missing a minimum assessment for a certain skill needed to complete the deadline, the system indicates the missing skill and periodically prompts that student to complete the skill and in some embodiments that the student is missing a skill needed for a standardized test.

In some embodiments, a workspace provided by the system to enable a user such as a student or teacher to drag-drop, handwrite, or use other forms of interaction with the problem or in an auxiliary module that is separate from the main workspace.

In some embodiments, the system accepts community collaboration such as sharing created problems, sharing teaching schedules, or allowing students to complete group-work. In some embodiments, a “forum” is used for students to up-vote important problems, selecting them for further review.

Weighted Proficiency Algorithm

FIG. 9 is a computer screen display depicting assessment of a user's skills and presentment of a skill proficiency assessment to the user while the user is working out problems 900 with an enhanced teaching and learning proficiency assessment and tracking system in accordance with some embodiments. In some embodiments, the system uses a proficiency algorithm to quantify or qualify a user's understanding of, or ability to complete, a specified skill or concept. The system tags problems and uses an associated score based on the user's success during problem completion. A proficiency algorithm beneficially changes the type of data teachers currently have available through grading individual problems and then having to sort through the many data points. The data generated and analyzed by the system assesses skill proficiency directly and presented as the ability to use a tool. As illustrated by way of example in FIG. 9, current educational practices require a teacher in one situation to go through 16,000 data points to assess a student's proficiency. By comparison, the systems and methods described herein assess the student's skill automatically during the learning process.

In some embodiments, the system uses a weighted algorithm to assess the proficiency of a user for a subject or skill In some embodiments, factors and weighting factors include experience, score, time, total attempts, correct attempts, incorrect attempts, number of steps, number of movements, hints, manual input, computer aid, group or individual work, solution method, and the like.

In some embodiments, the weighted algorithm outputs a percentage, real number, qualitative assessment, or the like. In one example, a user will be assessed based on experience points, score, and decay of assessed skill over time.

FIG. 10 is a computer screen display depicting tables displaying proficiency tracking 1000 with an enhanced teaching and learning proficiency assessment and tracking system in accordance with some embodiments. In some embodiments, a user earns experience points based on their score for each skill in a problem. For example, a score less than 3 yields 0 experience points, a score inclusive of 3 but less than 5, yields 0.3 experience points, a score inclusive of 5 but less than 7 yields 0.7 experience points, a score inclusive of 7 and 9 yields 1 experience point, and a score of 10 yields 2 experience points. In this fashion, the student is rewarded with experience points based on assessed performance and gains experience points much more quickly with a better score. Therefore, the earning of experience points for users who are already familiar with the skills is expedited.

In some embodiments, if a student completes a problem with no use of hints and no errors, they will receive a score of 10 for that assessment. If a user makes one or multiple errors, the system reveals each line which contains an error and prompts the user to retry the problem at the first point of error; each time the problem gets graded and there is at least one error, 2 points will be subtracted from their score with a minimum number of points being 0. Grading occurs either after the student submits the problem for grading or during problem work out. For every hint a student uses, 1 point will be subtracted from their score. In some embodiments, the ability to use hints on a problem is determined by a teacher. If a student ceases work on a problem to a correct solution, that student receives a score of 0 for that problem. In some embodiments, scoring for a problem is associated with each skill tagged in the problem. In some embodiments, a skill is scored separate from other tags of a problem if it is only used to solve a portion of the problem. An example is the skill of factoring where the full problem involves other tags and a student uses the factoring skill to complete a portion of the problem.

A student who is more familiar with a problem, and therefor has a higher experience level and experience points, may learn more quickly than a student who is unfamiliar with a problem. In some embodiments, their scores are multiplied by a weight factor, thereby allowing the system to recognize that a student will learn or re-learn more quickly once they have already worked the problem many times. In some embodiments, users who have experience points greater than 50 in each skill and receive a score equal to or above 9, and a weight factor of 1.5 is multiplied to their score.

In some embodiments, a proficiency score or rating is expressed as a percentage. If a student had 100 experience points and had 10 scores of 9.4, 8.6, 8.8, 9.2, 10, 8.2, 8.6, 8.4, and 8.8, a weight of 1.5 is multiplied by scores 9.4, 9.2, and 10 and the rest are multiplied by a weight factor of 1. The resulting weighted scores are then 14.1, 8.6, 8.8, 13.8, 15, 8.2, 8.6, 8.4, 8.8, and 13.8. The total score of the previous 10 is 93.8 and is divided by the sum of weights which is three weights of 1.5 (sum of 4.5) and 7 weights of 1 (sum of 7) which equals 11.5. In this example implementation, the proficiency of the student would be 9.08/10, rounded to 91 percent.

Generally speaking, users do not completely retain knowledge or skill over time and, accordingly, the systems and methods described herein gauge this loss of retention by assessing “decay” of a skill In some embodiments, depending on the experience points a user has for a skill and the amount of time elapsed since the user has last received a score for a skill, the user has their 10th last score deducted by 1 until that score reaches 0, and then the 9th last score will be deducted by 1 until it reaches 0 and so on until the 3rd last score is the first non-zero score. In some embodiments, the interval of deductions depends on experience points, or any other suitable factor. For example, if a student has 100 experience points, the system deducts points from their score in intervals of 35 days. The system also deducts experience points on these intervals. In one example the system deducts 1 experience point on the interval. Therefore, if a student has 100 experience points and associated with 35 day interval decay, it would take that student 350 days to reach an experience level of 90. At that point, the student is in a new interval decay bracket where the interval is 28 days, for example. This enables the rate of decay to increase after a long time of inactivity with a certain skill In the above example of student scores and deductions, after 35 days of inactivity the student has a new experience level of 99 and a 10th last score of 8.4 and new proficiency of 80 percent.

FIG. 11 is a block diagram of a computer system portion of an enhanced teaching and learning proficiency assessment and tracking system in accordance with some embodiments. In some embodiments, the computer system 1100 is part of the repositories of teacher processing device 104 (FIG. 1). In other embodiments, the computer system 1100 is part of the student processing devices 106 (FIG. 1). Computer system 1100 includes a hardware processor 1182 and a non-transitory, computer readable storage medium 1184 encoded with, i.e., storing, the computer program code 1186, i.e., a set of executable instructions. The processor 1182 is electrically coupled to the computer readable storage medium 1184 via a bus 1188. The processor 1182 is also electrically coupled to an I/O interface 1190 by bus 1188. A network interface 1192 is also electrically connected to the processor 1102 via bus 1188. Network interface 1192 is connected to a network 1194, so that processor 1182 and computer readable storage medium 1184 are capable of connecting and communicating to external elements via network 1194. An inductive loop interface 1196 is also electrically connected to the processor 1182 via bus 1188. Inductive loop interface 1196 provides a diverse communication path from the network interface 1192.

In some embodiments, inductive loop interface 1196 or network interface 1192 are replaced with a different communication path such as optical communication, microwave communication, or other suitable communication paths. The processor 1182 is configured to execute the computer program code 1186 encoded in the computer readable storage medium 1184 in order to cause computer system 1100 to be usable for performing a portion or all of the operations as described with respect to an enhanced teaching and learning proficiency assessment and tracking system.

In some embodiments, the processor 1182 is a central processing unit (CPU), a multi-processor, a distributed processing system, an application specific integrated circuit (ASIC), and/or a suitable processing unit.

In some embodiments, the computer readable storage medium 1184 is an electronic, magnetic, optical, electromagnetic, infrared, and/or a semiconductor system (or apparatus or device). For example, the computer readable storage medium 1184 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 1184 includes a compact disk-read only memory (CD-ROM), a compact disk-read/write (CD-R/W), a digital video disc (DVD) and/or Blu-Ray Disk.

In some embodiments, the storage medium 1184 stores the computer program code 1186 configured to cause computer system 1100 to perform the operations as described with respect to the enhanced teaching and learning proficiency assessment and tracking system.

In some embodiments, the storage medium 1184 stores instructions 1186 for interfacing with external components. The instructions 1186 enable processor 1182 to generate operating instructions readable by identity mapping system.

Computer system 1100 includes I/O interface 1190. I/O interface 1190 is coupled to external circuitry. In some embodiments, I/O interface 1190 includes a keyboard, keypad, mouse, trackball, trackpad, and/or cursor direction keys for communicating information and commands to processor 1182.

Computer system 1100 also includes network interface 1192 coupled to the processor 1182. Network interface 1192 allows computer system 1100 to communicate with network 1194, to which one or more other computer systems are connected. Network interface 1192 includes wireless network interfaces such as BLUETOOTH, WIFI, WIMAX, GPRS, or WCDMA; or wired network interface such as ETHERNET, USB, or IEEE-1394.

Computer system 1100 also includes inductive loop interface 1096 coupled to the processor 1182. Inductive loop interface 1196 allows computer system 1100 to communicate with external devices, to which one or more other computer systems are connected. In some embodiments, the operations as described above are implemented in two or more computer systems 1100

Computer system 1100 is configured to receive information related to the instructions 1186 through I/O interface 1190. The information is transferred to processor 1182 via bus 1188 to determine corresponding adjustments to the transportation operation. The instructions are then stored in computer readable medium 1184 as instructions 1186.

FIG. 12 is a flowchart of method of assessing and tracking learning proficiency with an enhanced teaching and learning proficiency assessment and tracking system in accordance with some embodiments. In operation 1202, the system is presenting a problem for solution by a student in a workspace displayed on a student processing device. In operation 1204, the system is assessing a plurality of lines entered by the student in the workspace for correctness and correspondingly providing scores for each of the plurality of lines. In operation 1206, the system is modifying a plurality of assessed skill levels each based on the scores for each of the plurality of lines.

FIG. 13 is a flowchart of method of assessing and tracking learning proficiency having score weighting with an enhanced teaching and learning proficiency assessment and tracking system in accordance with some embodiments. In operation 1302, the system is presenting a problem for solution by a student in a workspace displayed on a student processing device. In operation 1304, the system is assessing a plurality of lines entered by the student in the workspace for correctness and correspondingly providing scores for each of the plurality of lines. In operation 1306, the system is weighting the scores for each of the plurality of lines based on a weighting factor to provide weighted scores. In operation 1308, the system is modifying a plurality of assessed skill levels each based on the weighted scores for each of the plurality of lines.

FIG. 14 is a block diagram of a workspace 1400 having a problem solution with multiple steps, one of the steps having multiple lines, in an enhanced teaching and learning proficiency assessment and tracking system in accordance with some embodiments. The workspace 1400 includes a problem solution 1402 having a step 1 1404, a step 2 1406, a step 3 1408 and a step X 1410. The term X designates a positive integer, e.g., 4, associated with the last step in problem solution 1402. Step 3 1408 includes a line 1 1412, a line 2 1414 and a line Y 1416. The term Y designates a positive integer, e.g., 3, associated with the last line in step 3 1408. Each line 1412, 1414, 1416 is an entry made by a user, such as a student. In some embodiments, the line 1412, 1414, 1416 is a multiple choice question, a table, a free form entry, an input of a variable, etc. All lines are evaluated by the system for mathematical accuracy, however, some lines correspond to assessed skills while other lines do not correspond to assessed skills For example, a student can make up a line t=7 that does not correspond to an assessed skill Thus lines 1412, 1414, 1416 are assessed by the system to mathematically correct or incorrect, but may or may not correspond to an assessed skill In another example, if a student is solving for slope of a line, and the student adds a line similar to m=rise/run, that is assessed separately. The system will not associate all skills of that step negatively if the error was solely in that line.

Steps 1404, 1406, 1408, 1410 include single lines or multiple lines. As shown in FIG. 14, step 3 1408 includes multiple lines. Some steps have multiple lines corresponding to an assessed skill, for example, lines 1412, 1414, 1416 of step 3 1408. Other steps have a single line corresponding to an assessed skill, for example, line 1418 of step 1404, line 1420 of step 2 1406, and line 1422 of step X 1408. A problem is selected such that the problem solution 1402 contains at least one assessed skill In some embodiments, the problem solution as a whole is also an assessed skill Each problem falls into a certain category based on the set of skills in the steps, which implies a learning method.

In some embodiments, the system has a governing equation for a problem and the system uses that governing equation to determine if the student's answers are mathematically correct and to check the validity of a function. For example, if y=mx+b is the governing equation of a problem (not presented to the student) and the student is presented with y=3x+5, the system checks to see if the student's answer forms the same line by checking multiple x-values and corresponding y values.

With respect to grading, in some embodiments, if the problem solution 1402 includes solving for a variable that has multiple solutions, the system makes the minimum number of solutions necessary to be correct equivalent to the order of the problem. For example, x̂2−1=0: here the order is 2 so the system checks both solution values (−1,1) and requires they both be correct. Another line could show (x+1)*(x−1)=0 and both values would again have to be correct. If one of the lines was (x−1)=0, the order would be 1, therefore only one of the values (−1,1) is correct. This also solves the problem of students using common math notation and not computer science notation such as (x−1)=0 AND (x+1)=0.

In some embodiments method is disclosed for assessing and tracking learning proficiency that includes presenting a problem for solution by a student in a workspace displayed on a student processing device and assessing a plurality of lines entered by the student in the workspace for correctness and correspondingly providing scores for each of the plurality of lines The method further includes modifying a plurality of assessed skill levels each based on the scores for each of the plurality of lines.

In some embodiments a method is disclosed for assessing and tracking learning proficiency that includes presenting a mathematical problem for solution by a student in a computer display workspace and assessing a plurality of lines entered by the student in the computer display workspace for mathematical correctness and correspondingly providing scores for each of the plurality of lines. The method further includes weighting the scores for each of the plurality of lines based on a weighting factor to provide weighted scores and modifying a plurality of assessed skill levels based on the weighted scores.

In some embodiments, an enhanced teaching and learning proficiency assessment and tracking system is disclosed that includes a student processing device for displaying a problem and a workspace, and recording an entry in a line made in the workspace and a teacher processing device communicatively coupled to the student processing device, the teacher processing device producing a score by assessing and weighting a skill for the entry.

One of ordinary skill in the art will recognize the operations of method 600 are merely examples and additional operations are includable, describe operations are removable and an order of operations are adjustable without deviating from the scope of method 600.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A method for assessing and tracking learning proficiency, comprising:
presenting a problem for solution by a student in a workspace displayed on a student processing device;
assessing a plurality of lines entered by the student in the workspace for correctness and correspondingly providing scores for each of the plurality of lines; and
modifying a plurality of assessed skill levels each based on the scores for each of the plurality of lines.

2. The method of claim 1 wherein the problem for solution requires a plurality of assessed skills to reach a correct solution.

3. The method of claim 1 wherein modifying the plurality of assessed skill levels further comprises weighting at least one of the plurality of assessed skills based on a weighting factor.

4. The method of claim 3 wherein the weighting factor is based a time-dependent variable.

5. The method of claim 4 wherein the time-dependent variable is experience points.

6. The method of claim 1 further comprising:
assessing an overall problem score based on assessed skill levels;
assessing experience points based on the overall problem score.

7. The method of claim 1 wherein the problem is a mathematical problem and correctness is mathematical correctness.

8. The method of claim 1 wherein the workspace is tabbed.

9. A method for assessing and tracking learning proficiency, comprising:
presenting a mathematical problem for solution by a student in a computer display workspace;
assessing a plurality of lines entered by the student in the computer display workspace for mathematical correctness and correspondingly providing scores for each of the plurality of lines;
weighting the scores for each of the plurality of lines based on a weighting factor to provide weighted scores;
modifying a plurality of assessed skill levels based on the weighted scores.

10. The method of claim 9 wherein the weighting factor is experience points.

11. The method of claim 9 wherein the weighting factor increases with time between modifying a plurality of assessed skill levels based on the weighted scores for a same skill

12. The method of claim 9 further comprising:
tagging a skill for completion in a problem.

13. The method of claim 9 further comprising:
activating a tool based on a threshold number of mathematically correct number of uses of a corresponding skill

14. The method of claim 13 wherein the tool is a mathematic equation.

15. The method of claim 14 wherein the mathematic equation is y=mx+b.

16. An enhanced teaching and learning proficiency assessment and tracking system, comprising:
a student processing device for displaying a problem and a workspace, and recording an entry in a line made in the workspace; and
a teacher processing device communicatively coupled to the student processing device, the teacher processing device producing a score by assessing and weighting a skill for the entry.

17. The enhanced teaching and learning proficiency assessment and tracking system of claim 16 wherein the student processing device displays a system recommended problem set based on the score.

18. The enhanced teaching and learning proficiency assessment and tracking system of claim 16 wherein the teacher processing device displays a system recommended problem set for a subset of a class of students based on aggregated student scores.

19. The enhanced teaching and learning proficiency assessment and tracking system of claim 16 wherein the score decays over time.

20. The enhanced teaching and learning proficiency assessment and tracking system of claim 16 wherein the score decays over time based on experience points.
